(19) United States
(12) Patent Application Publication
(10) Pub. No.: US 2005/0209790 A1
(43) Pub. Date: Sep. 22, 2005

(54) Method and apparatus for remote servicing of an external component of an installed medical system

(76) Inventor: Matthias Niethammer, Erlangen (DE)

Correspondence Address: SCHIFF HARDIN LLP;Patent Department, 6600 Sears Tower, 233 South Wacker Drive, Chicago, IL, 60606, US

(21) Appl. No.: 10/804,683

(22) Filed: Mar. 19, 2004

(51) Int. Cl. G21K 1/12

(52) U.S. Cl. 702/28

(57) ABSTRACT

In a method and an apparatus for remotely servicing an external device that is used in conjunction with an installed medical device, the installed medical device is provided with remote access equipment allowing remote servicing of the installed medical system. When an external device is connected to the installed medical system, a control unit of the installed medical system routes a communication link between the external device and the service center, using the remote access equipment of the installed medical system, thereby allowing remote servicing of the external device. The manufacturer of the installed medical system can impose a charge on the manufacturer of the external device for use of the installed medical system's remote access equipment.

### BACKGROUND OF THE INVENTION

1. Field of the Invention

The present invention concerns a method and an apparatus that allow an external component of an installed medical system to be remotely serviced.

2. Description of the Prior Art

Modern clinics and hospitals generally have multiple types of imaging modalities installed in different rooms or suites of the clinic or hospital. Such an installation typically involves a permanent installed scanner, such as a scanner for magnetic resonance imaging, a gantry-based scanner for computed tomography for a C-arm based radiological scanner for CT and/or conventional radiography. Each installation room also contains a number of external devices that are commonly used with the installed device. In a radiological suite, for example, in addition to the scanner there may be one or more power contrast agent injectors, respirators, cameras etc. The installed device as well as the external devices all require maintenance and servicing.

Because of their larger size and complexity, many modern installed medical imaging systems have a built-in capability for remote servicing. For this purpose, the installed medical device, such as a scanner, has a modem port, a hardwired port, a wireless communication system, or some other suitable manner of communicating with service personnel located remote from the scanner. Such remote service technology enables technicians to diagnose the status of the system and to analyze errors without the need to be present at the site of the installed device. Among the advantages of remote service technology are lower service costs, faster service and repair, and less downtime and higher reliability.

A medical installation equipped with remote service technology can be applied to the following specific situations. Log files can be compiled at the installed device over time during usage of the device, and downloaded to a remote location for analysis to identify error patterns. It is also possible for the scanner to automatically initiate and establish a communication link with a remote service center if an error routine executed within the device detects an error. Even if it may be unavoidable in some circumstances for a service technician to make a service call to the installation location, by virtue of having already analyzed the problem by means of remote access, the technician can know in advance which replacement parts must be brought to correct the problem. Remote access technology also allows remote installation of software updates and software upgrades.

Although remote access technology has the aforementioned advantages, it has not found widespread use in hospitals and clinics because of the cost associated therewith. Most of these costs involve the components and labor that are necessary to set up the capability for remote access. Remote access needs additional LAN or telephone lines, or a wireless communication arrangement. Moreover, hospitals require a high level of IT-security to protect the privacy of the patients. This creates further expenses in terms of organization, technical implementation, documentation as well as presenting regulatory issues.

For these reasons, when remote access technology has been used in hospitals and clinics, it has only been cost-justified for use with very expensive and complex medical equipment, such as installed imaging modalities such as MRI scanners, CT scanners and the like. As noted above, however, each imaging modality installation typically involves a number of smaller external devices that are commonly used with the installed scanner. All of these devices require periodic maintenance and servicing as well, however, their relatively lower cost does not justify the expense of providing each of those external devices with remote access technology of its own.

### SUMMARY OF THE INVENTION

It is an object of the present invention to make remote access technology cost-justifiable for smaller, less costly devices, such as external devices that are commonly employed in connection with an installed medical imaging scanner.

It is a further object of the present invention to provide a method and an apparatus that expand the business opportunities for manufacturers of medical imaging installations that have remote access technology built-in or retrofitted, so as to make that remote access technology available to manufacturers of external devices that are typically used with the installed system.

The above object is achieved in accordance with the principles of the present invention in an apparatus including an installed medical system controlled or operated by a control unit and wherein the control unit is able to communicate via remote access technology with a remote location for servicing and maintenance. The apparatus also includes one or more external devices that are commonly used in conjunction with the installed medical system. The installed medical system has an external device interface via which the external device, when used, is able to communicate with and be controlled by the control unit of the installed system. When the external device is in communication with the interface, the control unit of the installed system serves as a router for allowing the external device to be remotely serviced via the remote access technology that is present for the installed system. A firewall, encryption technology, or other suitable software or electronic protection is provided to insulate the external device from the other components of the system during remote access to the external device, so that the remote servicing of the external device does not comprise the security of the installed system.

The above object also is achieved in accordance with the present invention in a method for remote servicing of an external device that is used in conjunction with an installed medical system, including the steps of building or retrofitting remote access technology into the installed medical system for use by the installed medical system, providing an interface between the installed medical system and at least one external device used with the installed medical system, allowing remote servicing of the external device connected to the interface via the system's remote access technology, and providing appropriate security between the interface and the other components of the installed system.

The above object also is achieved in a method of doing business wherein a manufacturer of installed medical equipment provides the installed medical equipment with remote access technology, either by building the remote access technology into the installed equipment or by retrofitting the installed equipment with remote access technology. The manufacturer also provides the installed equipment with an interface for at least one external device, and programs or hardwires the control computer of the installed device to allow and/or supervise remote access servicing of the external device, when connected to the interface, via the remote access technology provided for the installed device. The manufacturer collects a charge from the manufacturer of the external device for allowing the remote access technology of the installed system to be used for remote servicing of the external device.

The method and apparatus in accordance with the invention have several advantages. Less administrative work and outlay are required, because the hospital or clinic needs to have only one responsible remote contact for a particular installed system. Higher security is achieved compared to the (theoretical) situation of every external device having its own remote access data link, since there is only one remote access data link that must be protected. Better customer satisfaction is achieved, because, with not only the installed device, but also all external devices being remotely serviceable, the overall operation of the installed device together with its external devices is subject to less downtime and in general is more reliably operable.

As used herein, “installed device” and “installed system” mean a device or system that is permanently or semi-permanently installed in a particular location, with no capability of frequent or easy removal or relocation of the installation. As such, an installed device or system typically will not encompass a portable system intended for use at multiple different locations. As used herein, an “installed device” or “installed system” means a device or system for which equipping with remote access technology is economically reasonable or justifiable.

### DESCRIPTION OF THE DRAWINGS

FIG. 1 is a schematic illustration of an apparatus constructed and operating in accordance with the principles of the present invention, in the example of a radiological computed tomography installation.

FIG. 2 is a block diagram illustrating the basic components associated with the computer in the embodiment of FIG. 1 for practicing the invention.

### DESCRIPTION OF THE PREFERRED EMBODIMENTS

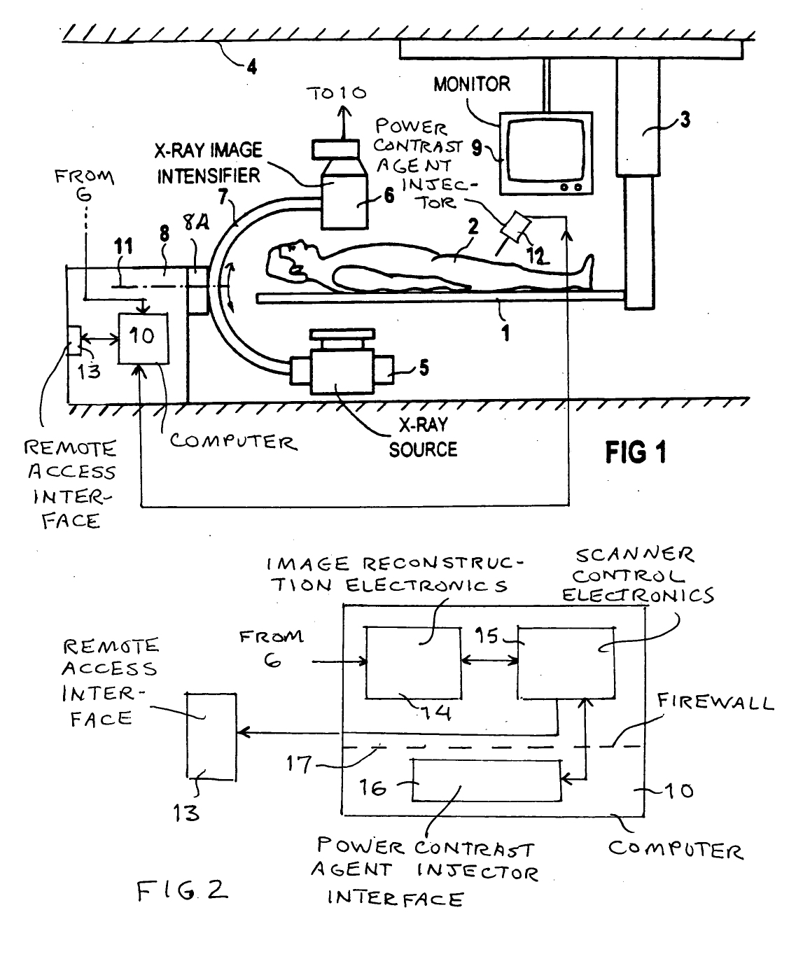

The inventive method and apparatus will be explained on the basis of FIGS. 1 and 2 in the example of a radiological computed tomography installation for generating images of an examination subject by computed tomography in a known manner. The method and apparatus, however, are not restricted to such an installation, but are generally applicable to any installation of a medical device that is used with one or more external devices.

In the example shown in FIG. 1, a computed tomography (CT) installation as a patient table 1 on which an examination subject, such as a patient 2, is placed. In the installation shown in FIG. 1, the table 1 is supported by a telescoping ceiling mount 3, however, a floor mount for the table 1 is equally applicable, as is a movable patient gurney or movable mount for the table 1. The particular manner of supporting the patient 2 is not a factor in determining whether the apparatus constitutes an “installation.”

The CT installation shown in FIG. 1 further includes an x-ray source 5 and an x-ray image intensifier 6 mounted in a known manner on a C-arm 7. The C-arm 7 is attached to a stand or pedestal 8 via a holder 8A. The C-arm 7 is movable in the holder 8A as indicated by the curved double-headed arrow to execute movement referred to as orbital, and the holder 8A together with the C-arm 7 are rotatable around an axis 11 to execute movement known as angulation.

In operation, x-rays emitted from the x-ray source 5 are attenuated by the patient 2 and are incident on the input screen of the x-ray image intensifier 6. In the x-ray image intensifier 6, the image at the input screen is intensified in signal strength to produce an image at an output screen that is converted to an electrical signal. The electrical signal is supplied to a computer 10 in the pedestal 8. In the computer 10, (or in a separate image computer connected thereto) the signal from the x-ray image intensifier 6 is converted into a video image, which is displayed on a monitor 9.

The electrical connection between the x-ray image intensifier 6 and the computer 10 is indicated in FIG. 1 as one example of the various connections that the computer 10 has to the components of the installation. The computer 10 also serves to control operation of the x-ray source 5, and to receive data concerning the operation thereof, via further communication lines that are not shown, and of course the computer 10 also communicates with the monitor 9 to supply the video signal thereto.

Different types of CT examinations require the use of one or more external devices in association with the CT installation of FIG. 1. As one example of such an external device, the installation shown in FIG. 1 has a power contrast agent injector 12 that is controlled via a control line by the computer 10. The power contrast agent injector 12 can be used, for example, in angiography and other types of examinations wherein imaging of blood vessels or vessel-like anatomy of the patient 2 is desired.

The computer 10 is connected to a remote access interface 13 in the pedestal 8. The remote access interface 13 can be a modem port, or some other type of hardwired connection, or a wireless transmitter/receiver arrangement operating on the basis of, for example, radio, infrared or ultrasound. The remote access interface establishes a data link (communication channel) with a service technician located remote from the installation shown in FIG. 1. The remote service installation includes personnel and equipment as are needed for all of the necessary support, maintenance and other servicing of the installation shown in FIG. 1, including the availability of software upgrades and updates. Via the remote access interface, the remote service center can analyze data compiled by the computer 10 during operation of the installation for the purpose of recognizing an error or an error pattern, detecting and identifying defectively operating components, etc. The aforementioned software upgrades and updates also can be transmitted to the computer 10 from the remote service center via the remote access interface 13. In summary, virtually all activities necessary for servicing the installation shown in FIG. 1, accept the actual physical replacement of a component, can be effected from the remote service center via the remote access interface 13. In accordance with the invention, and as explained in more detail in connection with FIG. 2, remote servicing of an external component, such as the power contrast agent injector 12, also can be undertaken from the remote service center via the remote access interface 13 and the computer 10.

As shown in FIG. 2, the computer 10 includes image reconstruction electronics 14 that receives the output from the x-ray image intensifier 6 for the purpose of reconstructing a CT image in a known manner. As also noted above, the image reconstruction can take place in a separate image reconstruction computer connected to the computer 10.

The computer 10 also contains scanner control electronics 15, which include all of the necessary software and hardware for operating and monitoring all of the components of the CT scanner, plus any external devices that are connected thereto at any given time. In the example of FIG. 1 employing the power contrast agent injector 12 as such an external device, the computer 10 includes a power contrast agent injector interface 16 to which the power contrast agent injector 12 when used, is connected. The interface 16 allows the scanner control electronics 15 also to control the operation of the power contrast agent injector 12.

In accordance with the invention, the scanner control electronics 15 also serves as a router, either by software programming or hardwired connections, to establish a data link or communication channel between the power contrast agent 12 and the remote access interface 13, thereby allowing remote servicing, from the aforementioned remote service center, of the power contrast agent injector 12, using the remote servicing technology of the installation shown in FIG. 1.

Depending on the type of external device that is involved, it may not be necessary to provide point-to-point communication between the actual external device and the remote service center. It may be sufficient for the scanner control electronics 15 to compile data, via the interface 16, during the operation of the device, and then to supply this data to the remote service center for use in remote access servicing of the external device. The important feature is that the external device itself does not need to contain any memory capacity or communication ability in order to be able to remotely serviced by the remote service center.

In addition to providing advantages for the customer for whom the CT apparatus has been installed, the present invention provides advantages for the manufacturer of the installation. As noted above, the installation shown in FIG. 1 can be provided with the remote access technology either as built-in components at the time of the installation, or as retrofitted components at a time after installation. Whenever the installation shown in FIG. 1 is provided with such remote access technology, the manufacturer or installer can make appropriate contractual arrangements with manufacturers or distributors of the external devices that are used with the installed device, to allow those external devices to be remotely serviced using the remote service technology of the installation (scanner). Such contractual arrangements can be a one-time payment, an annual fee, or a fee that is paid each time the external device is remotely serviced.

Needless to say, more than one external device can communicate with the scanner control electronics 15 through an interface that is appropriate for the particular device. More than one external device, therefore, can be remotely serviced using the same remote service technology of the scanner. If multiple channels for communication are provided, the remote servicing can ensure in parallel, however, remote servicing of one external device at a time is the simplest and the least expensive alternative.

When medical data are obtained, it is usually necessary, either due to internal hospital or clinic procedures or due to state or federal regulations, to take steps to ensure the security of the data to protect the privacy of the patient. For this purpose, the computer 10 must include suitable protection to isolate the external device from the data and other components in the installation, when the scanner control electronics is serving as a router for remote servicing of the external device. As an example of such protection, the embodiment shown in FIG. 2 includes a schematically indicated firewall 17 to provide such isolation. Any other known and suitable type of protection can be employed, however, such as separated hardwired connections within the scanner control electronics 15, encryption, security modules, and the like. In general, the necessary security can be provided either by hardware or software, as long as the aforementioned internal procedures and governmental regulations are satisfied.

Although modifications and changes may be suggested by those skilled in the art, it is the intention of the inventors to embody within the patent warranted hereon all changes and modifications as reasonably and properly come within the scope of their contribution to the art.

1. A medical apparatus comprising:
an installed medical system having a control unit for operating the installed medical system;
a remote access interface connected to the control unit for allowing the control unit to communicate with a remote location for remote servicing of the installed medical system;
an external device usable in combination with said installed medical system;
said installed medical system having an interface connected to said control unit, and connectible to said external device when used in combination with said installed medical system, for allowing communication between said control unit and said external device; and
said control unit comprising a router for placing said external device in communication with said remote access interface, via said external device interface, for allowing remote servicing of said external device from said remote location.

2. An apparatus as claimed in claim 1 wherein said installed medical system is a computed tomography system and wherein said external device is a power contrast agent injector.

3. An apparatus as claimed in claim 1 wherein said control unit comprises security protection for isolating said external device from a remainder of said installed medical system not involved in the remote servicing of the external device.

4. An apparatus as claimed in claim 3 wherein said security protection comprises security hardware.

5. An apparatus as claimed in claim 3 wherein said security protection comprises security software.

6. An apparatus as claimed in claim 1 wherein said remote access interface is built into said installed medical system as an original component.

7. An apparatus as claimed in claim 1 wherein said remote access interface is retrofitted into said installed medical system.

8. A method for remotely servicing an external device used in combination with an installed medical system, comprising the steps of:
providing an installed medical system with remote access equipment allowing remote servicing of said installed medical system;
connecting an external device to said installed medical system; and
temporarily connecting said external device to said remote access equipment in said installed medical system for allowing remote servicing of said external device.

9. A method as claimed in claim 8 wherein the step of providing said installed medical installation with remote access equipment comprises building said remote access equipment into said installed medical device at a time of installation of said installed medical device.

10. A method as claimed in claim 8 wherein the step of providing said installed medical device with remote access equipment comprises retrofitting said installed medical system with said remote access equipment after installation of said installed medical system.

11. A method for servicing an external device used in combination with an installed medical device, comprising the steps of:
establishing a communication link between an installed medical device and a service center remote from said installed medical device;
via said communication link, remotely servicing said installed medical device from said service center;
temporarily connecting an external device to said installed medical device; and
routing said communication link from said installed medical device to said external device; and
remotely servicing said external device from said service center through said installed medical system.

12. A method for charging for servicing of an external device used in combination with an installed medical device, comprising the steps of:
installing an installed medical device manufactured by a first manufacturer;
providing said installed medical device with remote access equipment allowing said installed medical system to communicate with a service center located remote from said installed medical device for remote servicing of said installed medical device;
connecting an external device, manufactured by a second manufacturer, to said installed medical system;
establishing communication, through said remote access equipment of said installed medical device, between said external device and said remote center for remotely servicing said external device; and
imposing a monetary charge by said first manufacturer to said second manufacturer dependent on said remote servicing of said external device.
